(19) United States
(12) Patent Application Publication
(10) Pub. No.: US 2026/0148433 A1
(43) Pub. Date: May 28, 2026

(54) METHOD, APPARATUS, DEVICE, AND STORAGE MEDIUM FOR VISUAL CONTENT GENERATION

(71) Applicants: Beijing Youzhuju Network Technology Co., Ltd., Beijing (CN); Lemon Inc., Grand Cayman (KY)

(72) Inventors: Shoufa CHEN, Beijing (CN); Chongjian GE, Beijing (CN); Fengda ZHU, Beijing (CN); Yuqi ZHANG, Beijing (CN); Yi JIANG, Los Angeles, CA (US); Zehuan YUAN, Beijing (CN); Bingyue PENG, Los Angeles, CA (US)

(21) Appl. No.: 19/329,305

(22) Filed: Sep. 15, 2025

(30) Foreign Application Priority Data
Nov. 25, 2024 (CN) 202411699139.X

(51) Int. Cl. G06T 11/00; G06F 40/40

(52) U.S. Cl. CPC G06T 11/00; G06F 40/40

(57) ABSTRACT

A method includes: determining, in response to obtaining description information related to visual content generation, position information of a respective text unit in the description information based on a specified visual category, the specified visual category indicating a video category or an image category, the position information including at least one of spatial position information or temporal position information; generating a visual feature map matching the description information by using a trained content generation model and based on text encoding representation and the position information of the respective text unit in the description information; and generating visual content matching the specified visual category by using a trained decoder model and based on the visual feature map, the decoder model being trained to decode an image from a visual feature map corresponding to the image and to decode a video from a visual feature map corresponding to the video.

### CROSS-REFERENCE

The present application claims priority to Chinese Patent Application No. 202411699139.X, filed on Nov. 25, 2024, and entitled “METHOD, APPARATUS, DEVICE, AND STORAGE MEDIUM FOR VISUAL CONTENT GENERATION”, which is incorporated herein by reference in its entirety.

### FIELD

Example embodiments of the present disclosure generally relate to the field of computers, and in particular, to a method, an apparatus, a device, a storage medium and a program product for visual content generation.

### BACKGROUND

In the field of media content generation, with the continuous advancement of technologies, image and video generation based on text description has become a research hotspot. With the continuous enrichment of application scenarios, users have put forward higher requirements for the diversity of generated media content.

Therefore, how to achieve the generation of diverse media content has become a direction for continuous exploration in this field.

### SUMMARY

In a first aspect of the present disclosure, a method of visual content generation is provided. The method may include: determining, in response to obtaining description information related to visual content generation, position information of a respective text unit in the description information based on a specified visual category, the specified visual category indicating a video category or an image category, the position information including at least one of spatial position information or temporal position information; generating a visual feature map matching the description information by using a trained content generation model and based on text encoding representation and the position information of the respective text unit in the description information; and generating visual content matching the specified visual category by using a trained decoder model and based on the visual feature map, the decoder model being trained to decode an image from a visual feature map corresponding to the image and to decode a video from a visual feature map corresponding to the video.

In a second aspect of the present disclosure, an apparatus for visual content generation is provided. The apparatus may include: a position information determination module configured to determine, in response to obtaining description information related to visual content generation, position information of a respective text unit in the description information based on a specified visual category, the specified visual category indicating a video category or an image category, the position information including at least one of spatial position information or temporal position information; a visual feature map generation module configured to generate a visual feature map matching the description information by using a trained content generation model and based on text encoding representation and the position information of the respective text unit in the description information; and a visual content generation module configured to generate visual content matching the specified visual category by using a trained decoder model and based on the visual feature map, the decoder model being trained to decode an image from a visual feature map corresponding to the image and to decode a video from a visual feature map corresponding to the video.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, causing the electronic device to perform the method of the first aspect.

In a fourth aspect of the present disclosure, a computer-readable storage medium is provided. The medium has a computer program stored thereon, the computer program, when executed by a processor, implementing the method of the first aspect.

In a fifth aspect of the present disclosure, a computer program product is provided. The computer program product includes computer-executable instructions which, when executed by a processor, implement the method of the first aspect.

It should be appreciated that the content described in this section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments of the present disclosure can be implemented;

FIG. 2 shows a flowchart of a method for visual content generation according to some embodiments of the present disclosure;

FIG. 3 shows a schematic diagram of a visual generation model according to some embodiments of the present disclosure;

FIG. 4 shows a schematic diagram of a processing block based on an attention mechanism according to some embodiments of the present disclosure;

FIG. 5 shows a schematic diagram of a training process of a content generation model according to some embodiments of the present disclosure;

FIG. 6 shows a schematic diagram of a training process of a decoder model according to some embodiments of the present disclosure;

FIG. 7 shows a schematic diagram of a generation process of a sample for model training according to some embodiments of the present disclosure;

FIG. 8 shows a schematic structural block diagram of an apparatus for video generation according to some embodiments of the present disclosure; and

FIG. 9 shows a block diagram of an electronic device that can implement one or more embodiments of the present disclosure.

### DETAILED DESCRIPTION

Embodiments of the present disclosure will be described in more detail below with reference to the drawings. Although certain embodiments of the present disclosure are shown in the drawings, it should be understood that the present disclosure may be implemented in various forms, and should not be interpreted as limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. The following may also include other explicit and implicit definitions.

Herein, unless explicitly stated, the execution of a step “in response to A” does not mean that the step is executed immediately after “A”, but may include one or more intermediate steps.

It may be understood that the data involved in the technical solution (including but not limited to the data itself, acquisition, use, storage or deletion of the data) should comply with requirements of corresponding laws, regulations and related provisions.

It may be understood that before using the technical solutions disclosed in the embodiments of the present disclosure, the type, range of use, use scenarios, etc. of the information involved in the present disclosure should be informed to the relevant users and the authorization of the relevant users should be obtained through appropriate means in accordance with relevant laws and regulations, where the relevant users may include any type of subject of rights, such as individuals, enterprises, groups.

For example, in response to receiving an active request from a user, prompt information is sent to the relevant user to clearly prompt the relevant user that the requested operation will need to obtain and use information of the relevant user, so that the relevant user may independently choose whether to provide the information to the software or hardware, such as an electronic device, an application, a server or a storage medium, that performs the operations of the technical solutions of the present disclosure according to the prompt information.

As an optional but non-restrictive implementation, in response to receiving the active request from the relevant user, the prompt information may be sent to the relevant user in the form of, for example, a pop-up window, in which the prompt information may be presented in text. In addition, the pop-up window may also carry a selection control for the user to select “agree” or “disagree” to provide the information to the electronic device.

It may be understood that the above process of notifying and obtaining user authorization is only illustrative, and does not limit the implementation of the present disclosure. Other methods that satisfy the relevant laws and regulations may also be applied to the implementation of the present disclosure.

As used herein, the term “model” may learn the association between corresponding inputs and outputs from training data, so that after the training is completed, the corresponding outputs may be generated for given inputs. The generation of the model may be based on machine learning techniques. Deep learning is a machine learning algorithm that uses multiple layers of processing units to process inputs and provide corresponding outputs. A neural network model is an example of a deep learning-based model. Herein, the “model” may also be referred to as a “machine learning model”, a “learning model”, a “machine learning network” or a “learning network”, which terms are used interchangeably herein.

In the field of multimodal generation technologies, the combination of text description and visual content generation is an important research direction. In common related technologies, text embedding is generated through a simple text encoding model, and then visual content is generated through a convolutional neural network. At present, image generation and video generation are usually processed separately, and independent feature extraction and generation modules are designed for images and videos respectively. This makes it difficult for the model to uniformly process data of different visual categories, which is inefficient in multimodal content generation tasks and consumes a large amount of training resources.

In the embodiments of the present disclosure, a solution for visual content generation is proposed. According to the solution, an electronic device determines position information of respective text unit in description information based on a specified visual category in response to obtaining the description information related to visual content generation, the specified visual category indicating a video category or an image category, and the position information including at least one of spatial position information or temporal position information; generates, using a trained content generation model and based on text encoding representations and the position information of the respective text unit in the description information, a visual feature map matching the description information; and generates, using a trained decoder model and based on the visual feature map, visual content matching the specified visual category, the decoder model being trained to decode an image or a video from a visual feature map corresponding to the image and a visual feature map corresponding to the video, respectively.

Through the above process, based on the design of a unified model framework, the multimodal unified processing of image generation and video generation is realized. By dynamically extracting different features according to visual categories (such as extracting spatial position information and temporal position information for the video category, and only extracting spatial position information for the image category), there is no need to separately design feature extraction and generation modules for images and videos, and the unified model supports both image generation and video generation, which significantly improves the processing capability of multimodal content generation tasks. The separation problem of separately designing independent feature extraction modules for different visual categories is solved.

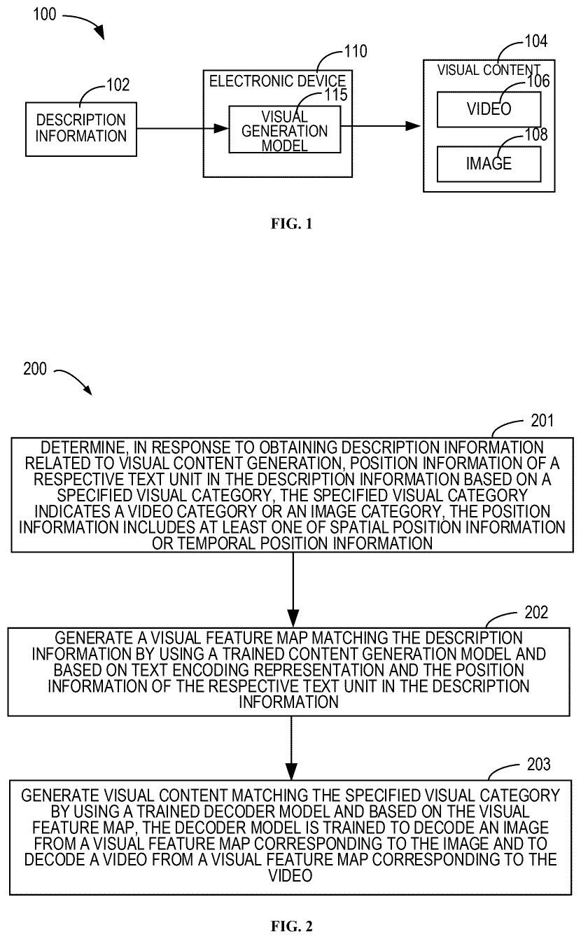

FIG. 1 shows a schematic diagram of an example environment 100 in which the embodiments of the present disclosure can be implemented. As shown in FIG. 1, the environment 100 may include an electronic device 110. In this example environment 100, the electronic device 110 may obtain description information 102 related to visual content generation. The electronic device 110 may use a visual generation model 115 to generate an image 108 or a video 106 corresponding to the description information 102 based on the description information 102. As an example, the description information 102 may contain information about a specified visual category, such as a generated video category or a generated image category. Based on the specified visual category, the visual generation model 115 may determine position information corresponding to the specified visual category, for example, the position information may include at least one of spatial position information or temporal position information. For example, if a video category is generated, the position information may include spatial position information and temporal position information. If an image category is generated, the position information may include spatial position information.

In the following, the visual generation model 115 may generate a visual feature map matching the description information based on text encoding representations and the position information of respective text unit in the description information. Based on the visual feature map, visual content 104 matching the specified visual category may be finally obtained. The visual content 104 may include the video 106 or the image 108. The visual generation model 115 may be a single model or a combination of multiple models. As an example, a content generation model may be used to generate the visual feature map matching the description information, and a decoder model may be used to generate the visual content 104 matching the specified visual category.

The electronic device 110 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a game device, or any combination of the foregoing, including the fittings and peripherals of these devices or any combination thereof. In some embodiments, the electronic device 110 may also support any type of user-oriented interface (such as a “wearable” circuit, etc.). The server device (not shown) may be various types of computing systems/servers that can provide computing power, including but not limited to mainframes, edge computing nodes, computing devices in cloud environments, and so on. The server device may, for example, provide a background service for an application of the electronic device 110.

It should be appreciated that the structures and functions of the elements in the environment 100 are described for illustrative purposes only, without suggesting any limitation to the scope of the present disclosure.

FIG. 2 shows an example process of a method 200 for visual content generation according to some embodiments of the present disclosure. For the convenience of discussion, the process 200 will be described with reference to the environment in FIG. 1. In the environment 100, the generation of visual content may be performed by the electronic device 110, but some of the operations may be performed by requesting a server device (not shown) (such as the determination of position information, the determination of a visual feature map, etc. In addition, the training process of some models involved in the visual content generation process may also be implemented at the server device).

At block 201, the electronic device 110 determines position information of a respective text unit in description information based on a specified visual category in response to obtaining the description information related to visual content generation, the specified visual category indicates a video category or an image category, and the position information includes at least one of spatial position information or temporal position information.

The description information 102 may include a set of text units provided by a user, automatically generated by the electronic device 110 or obtained from other devices. The description information 102 may be used to describe the content, features or scenes of the target visual content, etc. The description information 102 may be in text format. In some embodiments, the description information 102 may include a description in the form of a natural language.

The specified visual category may indicate an image category or a video category, which may be determined by user needs or contextual information during communication with the user. For example, the specified visual category may be determined as an image category or a video category by user input, history records or automatic judgment of the electronic device 110. In some embodiments, based on the visual category, the electronic device 110 may extract the position information of respective text unit in the description information, where the spatial position information in the position information may be used to describe the spatial distribution of relevant content in an image or a video frame, for example, including the positional relationship, image structure, etc. The temporal position information in the position information may be used to describe the temporal variation characteristics of the content in a video.

At block 202, the electronic device 110 generates, using a trained content generation model and based on text encoding representations and the position information of the respective text unit in the description information, a visual feature map matching the description information.

The content generation model refers to that it is able to determine, based on model inputs (i.e., the description information), the content generation intention in the model inputs and output the corresponding feature sequence. The feature sequence may be decoded to obtain the desired content. In the embodiments of the present disclosure, for the scenario of visual generation, the output of the content generation model is a visual feature map for visual content generation. In some embodiments, the output of the content generation model includes a sequence of visual feature units (also referred to as tokens, token), which may form the visual feature map in sequence.

The position information of the respective text unit in the description information refers to the spatial position or temporal position related to each text unit in the description information, and is used to define the three-dimensional information of space and time in the visual content generation process. For example, in a visual content generation scenario, the text unit may correspond to the semantic information that describes the position, action or scene of a specific object. The spatial position information may include the relative coordinates of the specific object in the image (such as the area of height and width), and the temporal position information may describe the appearance moment or duration of the specific object on the time axis. In order to combine the position information more efficiently, 3D RoPE Position Embedding (three-dimensional rotational position encoding) may be adopted. This method can embed the spatial and temporal information, and combine the position information of the text unit with its semantic information to provide more accurate and rich contextual information, which may then be used to guide the content generation model to generate a matching visual feature map.

FIG. 3 shows a schematic diagram of a visual generation model 115 according to some embodiments of the present disclosure. The content generation model 115-a in the visual generation model 115 may fuse the text encoding representations 301 of the respective text units with their corresponding position information 302, and convert them into a visual feature map through feature compression and mapping. The text encoding representations 301 of the respective text unit may indicate the semantic features of the text. In addition, the spatial position information (such as the height H and width W of an image or a video frame) and temporal position information (such as the frame sequence or duration T in a video) associated with each text unit are integrated into the text encoding to guide the generation process of visual features. If it corresponds to an image, the temporal position information T may be set to a null value. The content generation model 115-a receives these fused representations and reduces and compresses their dimensions through a multi-layer network to generate a visual feature map with the dimension of T′×H′×W′.

The essence of the feature compression process in the content generation model 115-a is to embed the high-dimensional text encoding representations 301 and position information 302 into a unified low-dimensional visual feature space, so that the generated visual feature map can not only reflect the semantic information in the text description, but also reflect the spatial and temporal distribution characteristics of the visual category (image or video). The generated visual feature map, as an intermediate representation, provides a basis for generating the target visual content (image or video) in the subsequent decoding stage.

At block 203, the electronic device 110 generates, using a trained decoder model and based on the visual feature map, visual content matching the specified visual category, the decoder model being trained to decode an image from a visual feature map corresponding to the image and to decode a video from a visual feature map corresponding to the video.

The visual feature map fuses the text semantic information, spatial position information and (for videos) temporal position information. For the image category, the decoder model 115-b restores the visual feature map to a high-resolution static image through a convolutional layer and up-sampling operation. For the video category, the decoder model 115-b also needs to combine the features in the temporal dimension to generate a continuous video clip with inter-frame dynamic coherence.

Through the above process, the multimodal unified processing of image generation and video generation is realized. By dynamically extracting different features according to visual categories (such as extracting spatial position information and temporal position information for the video category, and only extracting spatial position information for the image category), there is no need to separately design feature extraction and generation modules for images and videos, and the unified model supports both image generation and video generation, which significantly improves the processing capability of multimodal content generation tasks.

In some embodiments of the present disclosure, the content generation model 115-a may include a diffusion model. The diffusion model has a self-attention mechanism to capture complex semantic relationships and spatial-temporal dependencies from the input information. For example, based on the text encoding representations and spatial position information of respective text unit in the description information, the position, structure and detail information of an object in a target scene may be captured in the height and width dimensions of an image or a video frame. In addition, based on the text encoding representations and temporal position information of respective text unit in the description information, the coherence and change trend of actions between consecutive frames of a video may be determined. The diffusion model may gradually improve visual features through the plurality of rounds of iteration and the self-attention mechanism to generate high-quality visual feature maps.

In some embodiments of the present disclosure, the content generation model 115-a may further include a processing block based on an attention mechanism (for example, a Transformer processing block), and the processing block of the attention mechanism may determine a query feature, a key feature and a value feature based on the description information and the position information of the respective text unit in the description information. Normalization processing is applied to the query feature and the key feature to obtain a normalized query feature and a normalized key feature. The value feature, the normalized query feature and the normalized key feature are provided as inputs to a processing block based on cross-attention to generate a visual feature map matching the description information.

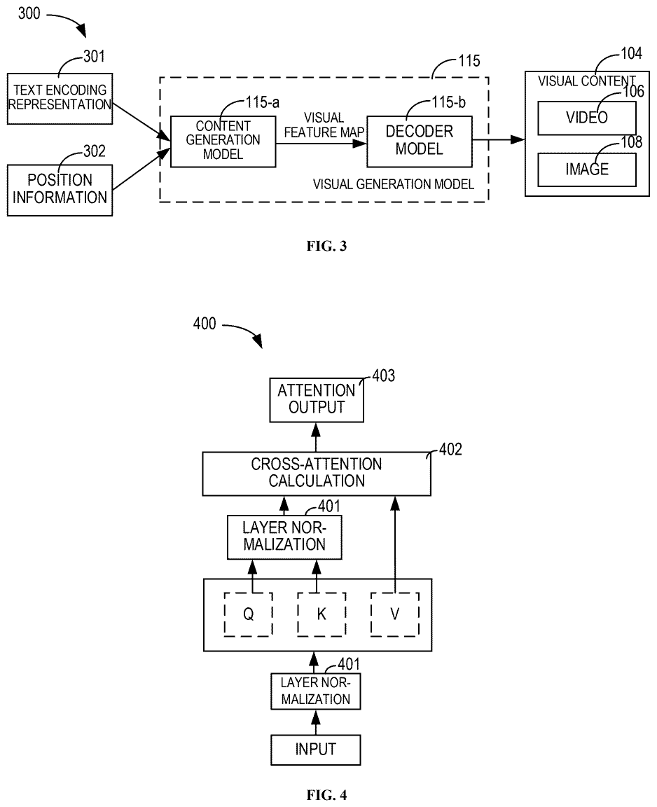

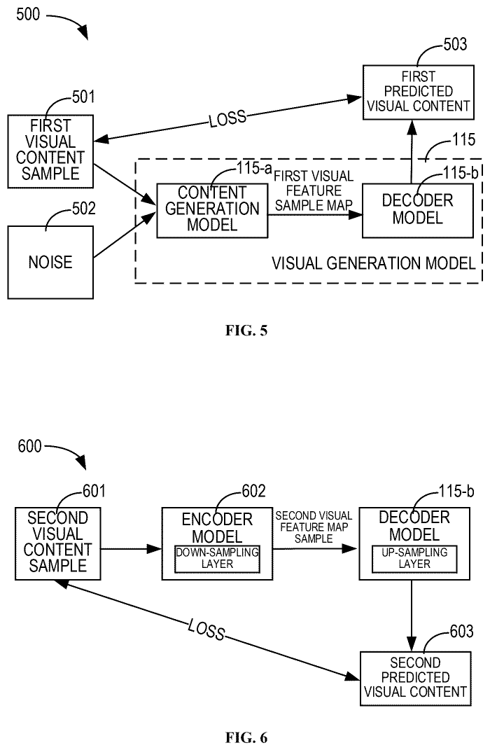

FIG. 4 shows a schematic diagram of a processing block 400 based on an attention mechanism according to some embodiments of the present disclosure. The input to the processing block 400 based on the attention mechanism may be the description information and the position information of the respective text unit in the description information. First, the input is processed through layer normalization 401 to obtain normalized input data. The purpose of the layer normalization 401 processing is to make the input information stable in numerical distribution. The standardized input data may generate a query feature (Q), a key feature (K) and a value feature (V).

The query feature (Q) and the key feature (K) are processed through another layer normalization 401, and then cross-attention calculation 402 is performed together with the value feature (V) to obtain attention output 403. Through the cross-attention calculation 402 process, the text description information may be associated with the visual features.

As mentioned above, the visual feature map is generated by using the content generation model 115-a. The following uses the electronic device 110 as the execution body of training to introduce the training process of the content generation model 115-a, but it should be understood that the training process of the model may be implemented on any appropriate device/system. The electronic device 110 may construct the plurality of first sample pairs formed by a first visual content sample and a first description information sample, the category of the first visual content sample in the plurality of first sample pairs including a video category and an image category. For each of the plurality of first sample pairs, the content generation model 115-a to be trained may be used to determine a first visual feature map sample matching the first description information sample in the first sample pair. Based on the first visual feature map sample, the trained decoder model 115-b is used to generate first predicted visual content matching the category of the first visual content sample. The content generation model 115-a is trained based on the difference between the first predicted visual content determined for the plurality of first sample pairs and the first visual content sample.

The training process of the content generation model 115-a is based on the construction of high-quality sample pairs, and the plurality of first sample pairs formed of a first visual content sample and a first description information sample need to be constructed first. How to construct the plurality of high-quality first sample pairs will be introduced later.

Multiple first sample pairs may be used to train the content generation model 115-a. The category of the first visual content sample in the plurality of first sample pairs includes a video category and an image category to cover the diversity of dynamic visual content and static visual content. The first description information sample matches the first visual content sample, and provides a semantic or scene-related text description as a basis for guiding generation.

In training, for each first sample pair, the content generation model 115-a to be trained is used to generate, according to the first description information sample, a first visual feature map sample matching the first description information sample. These first visual feature map samples contain not only the semantic features of the description information, but also the category information of the visual content.

The electronic device 110 may use the trained decoder model 115-b to generate first predicted visual content based on the generated first visual feature map sample, the category of the first predicted visual content being consistent with the original first visual content sample. For the video category, the trained decoder model 115-b may generate plurality of consecutive frames of pictures. For the image category, the trained decoder model 115-b may generate a single frame of static image.

The electronic device 110 compares the generated first predicted visual content with the corresponding first visual content sample to calculate the difference between them. The difference may be quantified by various loss functions, such as pixel-level mean squared error loss (MSE) or semantic consistency loss, to evaluate the restoration quality of the predicted content.

The electronic device 110 optimizes the parameters of the content generation model 115-a iteratively based on the difference between the first predicted visual content and the corresponding first visual content sample. This training process not only considers the different characteristics of visual content categories, but also achieves the goal of unified processing of two visual forms: images and videos, providing an efficient and flexible solution for multimodal generation tasks.

For the determination of the first visual feature map sample matching the first description information sample in the sample pair, during the training process, the electronic device 110 may weight the first visual content sample with a first weight to obtain a weighted first visual content sample; weight noise with a second weight to obtain weighted noise, the first weight and the second weight being determined based on an iteration step of content iteration generation of the content generation model; and fuse the weighted first visual content sample and the weighted noise to obtain the first visual feature map sample.

FIG. 5 shows a schematic diagram of a training process 500 of a content generation model 115-a according to some embodiments of the present disclosure. In the training process, the first visual content sample 501 and noise 502 may be weighted, and the weighting may be expressed as follows:

$${x}_{t} = t \cdot {x}_{1} + ( 1 - t ) {x}_{0} \qquad ( 1 )$$

xₜ may represent a first visual feature map sample added with noise. x₁ may represent the first visual content sample 501, and the size of the first visual content sample 501 may be expressed as T×H×W, where T may represent time information (if it is an image, T=1, which may be regarded as the temporal position information being set to a null value), H may represent height information, and W may represent width information. x₀ may represent the noise 502 added to the first visual content sample. As an example, the noise 502 may be random noise. t may represent a hyperparameter based on the iteration step, and the value range of t is between 0 and 1, which is used to control the weighting ratio of the first visual content sample 501 and the noise 502.

The electronic device 110 may use a dynamic weighting mechanism to weight the first visual content sample 501 and the noise 502. The first visual content sample 501 is weighted by the first weight (t) to obtain the weighted first visual content sample. At the same time, the noise 502 is weighted by the second weight (1-t) to obtain the weighted noise. Subsequently, the electronic device 110 linearly fuses the weighted first visual content sample and the weighted noise to generate the first visual feature map sample xₜ added with noise.

The value of the hyperparameter t of the iteration step may be dynamically determined by the iteration step of the content generation model 115-a. As an example, in the initial iteration stage (t is close to 0), the weight is completely biased towards the noise 502, and the first visual feature map sample 501 may be mainly composed of the noise 502. In the later stage of generation (t is close to 1), the weight gradually shifts to the first visual content sample 501, and the first visual feature map sample 501 is close to the real target feature. This dynamic change process may enable the content generation model 115-a to smoothly transition from the noise domain to the real data domain, and fully capture the semantic information of the visual content sample in this process.

The encoder model 115-b may determine first predicted visual content 503 based on the visual feature map generated by the content generation model 115-a. Based on the difference between the first predicted visual content 503 and the first visual content sample 501, the training of the content generation model 115-a may be completed.

In the above training process, by dynamically adjusting the ratio of the visual content sample to the noise, the content generation model 115-a may adaptively adjust the weight distribution according to different description information and visual content categories, so that the content generation model 115-a may generate the first visual feature map sample that highly matches the description information and has excellent visual quality.

The following describes the training process of the decoder model 115-b. The electronic device 110 may use an encoder model to process a second visual content sample to obtain a second visual feature map sample of the second visual content sample; generate, using the decoder model 115-b to be trained and based on the second visual feature map sample, second predicted visual content matching the second visual content sample; and train the decoder model based on a difference between the second predicted visual content and the second visual content sample.

FIG. 6 shows a schematic diagram of a training process 500 of a decoder model 115-b according to some embodiments of the present disclosure. In the training process of the decoder model 115-b, an encoder model 602 may be used. The encoder model 602 is used to process a second visual content sample 601 to obtain a second visual feature map sample of the second visual content sample 601.

It is assumed that the size of the second visual content sample 601 may be expressed as T×H×W, where T may represent the temporal dimension (for video content, T=1 represents a static image), and H and W may represent the height and width of the visual content, respectively. Through the processing of the encoder model 602, the second visual content sample 601 may be compressed into a second visual feature map sample with the size of T′×H′×W′, where the values of T′, H′ and W′ are less than T, H and W, respectively. The second visual feature map sample retains the core semantics and structural features of the second visual content sample 601 while significantly reducing the data dimension.

The decoder model 115-b to be pre-trained is used to generate second predicted visual content 603 matching the second visual content sample 601 based on the second visual feature map sample. The task of the decoder model 115-b is to gradually restore the second visual feature map sample with the size of T′χH′×W′ to the second predicted visual content 603 with the size of T×H×W. In this process, the decoder model 115-b needs to recover the detail information of the visual content from the latent features, including color, texture, dynamic changes (for the video category), etc., to ensure the consistency of the generation result in terms of details and global structure.

Based on the difference between the second predicted visual content 603 and the second visual content sample 601, the training of the decoder model 115-b may be completed. The difference may include at least one of the following: a pixel distance difference between the second predicted visual content 603 and the second visual content sample 601, a perceptual feature difference between the second predicted visual content 603 and the second visual content sample 601, or a distribution distance difference between the second predicted visual content 603 and the second visual content sample 601.

The pixel distance difference between the second predicted visual content 603 and the second visual content sample 601 may be expressed as follows:

$${L}_{1} = \vert x - {x}^{′} \vert \qquad ( 2 )$$

x and x′ may represent the pixel representations of the second predicted visual content 603 and the second visual content sample 601 at corresponding pixel positions, respectively.

The perceptual feature difference between the second predicted visual content 603 and the second visual content sample 601 may be expressed as follows:

$${L}_{v gg} = \frac{1}{L} Σ \vert VG {G}_{l} ( x ) - V G {G}_{l} ( {x}^{′} ) \vert \qquad ( 3 )$$

VGGₗ(x) and VGGₗ(x′) may represent the feature representations of the second predicted visual content 603 and the second visual content sample 601 after passing through a feature extraction network (such as a visual geometry group network), respectively. The perceptual feature difference is to compare the difference between the second predicted visual content 603 and the second visual content sample 601 in the high-level feature space.

The distribution distance difference between the second predicted visual content 603 and the second visual content sample 601 may be expressed as follows:

$${L}_{K L} = \frac{1}{2} {\sum }_{c = 1}^{C} ( 1 + log ( {σ}_{c}^{2} ) - {μ}_{c}^{2} - {σ}_{c}^{2} ) \qquad ( 4 )$$

σ_{c} and μ_{c} may represent the latent distribution of the second predicted visual content 603 in the C-th dimension and the prior distribution of the second visual content sample 601 in the C-th dimension, respectively. The distribution distance difference is to compare the difference between the second predicted visual content 603 and the second visual content sample 601 in the C-th dimension of the latent space.

In addition, during the training process of the decoder model 115-b, a generator and a discriminator may also be used to optimize each other through adversarial training. The decoder model 115-b may be used as the generator. The decoder model 115-b generates the second predicted visual content based on the second visual feature map sample. After receiving the second predicted visual content and the second visual content sample, the discriminator determines whether they come from the second visual content sample distribution or the second predicted visual content distribution, respectively.

The loss function of the discriminator may be expressed as follows:

$${L}_{D} = - 𝔼 x ∼ {p}_{d a t a} ( x ) [ log D ( x ) ] - 𝔼 z ∼ q ϕ ( z \vert x ) [ log ( 1 - D ( G ( z ) ) ] \qquad ( 5 )$$

D(x) may represent the prediction probability of the discriminator for the second visual content sample. D(G(z)) may represent the prediction probability of the discriminator for generating the second predicted visual content. p_{data} may represent the distribution of the second visual content sample. qφ(z|x) may represent the conditional distribution. [symbol] x may represent the average evaluation of the prediction performance of all real data samples, and [symbol] z may represent the expectation of a random variable.

The loss function of the generator may be expressed as follows:

$$ℒ G = - 𝔼 z ∼ {q}_{ϕ} ( z \vert x ) [ log D ( G ( z ) ) ] \qquad ( 6 )$$

G(z) may represent that the generator generates the second predicted visual content based on the second visual feature map sample. D(G(z)) may represent the prediction probability of the discriminator for generating the second predicted visual content. Through this adversarial training, the generator continuously improves the authenticity and diversity of the generated content, and the discriminator continuously optimizes the discrimination capability. Finally, the visual content generated by the generator approaches the real sample in terms of feature distribution, thereby realizing high-quality visual content generation.

In order to reduce the computational complexity, the encoder model 602 includes a down-sampling layer, and the decoder model 115-b includes an up-sampling layer. The down-sampling layer is configured to down-sample the second visual content sample 601 in response to the second visual content sample 601 being a video and by using a first compression stride in a spatial dimension and a second compression stride in a temporal dimension to obtain the second visual feature map sample; or down-sample the second visual content sample 601 in response to the second visual content sample 601 being an image and by using the first compression stride in the spatial dimension to obtain the second visual feature map sample. The up-sampling layer is configured to up-sample the second visual feature map sample in response to the second visual content sample 601 being a video and by using a first expansion stride in the spatial dimension and a second expansion stride in the temporal dimension to generate the second predicted visual content.

The down-sampling layer of the encoder model 602 maps high-dimensional data into low-dimensional representation by compressing the input second visual content sample 601 in the spatial dimension and the temporal dimension, thereby reducing the consumption of computing resources while retaining key features. For a video, the encoder model 602 uses the first compression stride (8 times) in the spatial dimension and the second compression stride (4 times or 8 times) in the temporal dimension to down-sample the video, and compresses the size of the second visual content sample 601 from T×H×W to a second visual feature map sample of T′×H′×W′. The height and width of the spatial dimension are compressed to H/8 and W/8, respectively, and the temporal dimension is compressed to T/4 or T/8. For an image, since the temporal dimension T=1, down-sampling is only performed in the spatial dimension, and a second visual feature map sample of size H/8×W/8 is generated by 8-fold compression.

The up-sampling layer of the decoder model 115-b is configured to restore the second visual feature map sample to high-dimensional second predicted visual content. For a video, the up-sampling layer of the decoder model 115-b uses the expansion strides of space and time to restore the second visual feature map sample from the size of T′×H′×W′ to the size of T×H×W, ensuring that the resolution and dynamic features of the generated video are consistent with the second visual content sample. For an image, the up-sampling layer of the decoder model 115-b only involves the spatial dimension and gradually restores to the original size H×W through the expansion stride. The up-sampling layer and the down-sampling layer may be implemented based on a 3D causal convolutional network. The encoder model 602 implements 8-fold spatial compression and 4-fold or 8-fold temporal compression through multi-layer convolutional operations with a stride of 2, and the decoder model 115-b gradually restores through a symmetric deconvolutional structure. This design reduces the computational complexity while maintaining the capture and reconstruction of key features in images and videos.

The following describes the construction process of the first sample pair. The electronic device 110 selects the plurality of visual content samples from candidate visual content samples based on a quality constraint of visual content samples; determines respective content categories corresponding to the plurality of visual content samples based on semantic labels of the plurality of visual content samples; determines, based on a balance requirement for visual content samples of different content categories, first visual content samples for constructing the plurality of first sample pairs from the plurality of visual content samples; and generates, based on the first visual content samples, first description information samples related to the first visual content samples to construct first sample pairs in the plurality of first sample pairs.

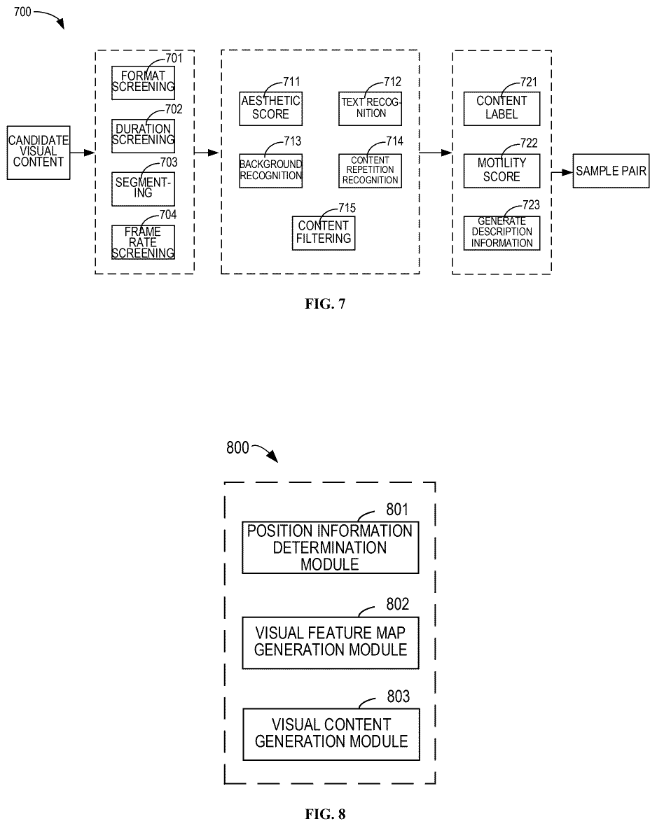

FIG. 7 shows a schematic diagram of the principle of a generation process of sample pairs 700 for model training according to some embodiments of the present disclosure. In the process of constructing the sample pairs, the electronic device 110 may screen a plurality of visual content samples from the candidate visual content samples based on the quality constraint of the visual content samples, and perform multi-level screening on them.

First, the electronic device 110 may perform preliminary screening on the visual content samples through format screening 701 and duration screening 702. If the format of the visual content sample does not meet the requirements or the duration is too short, it may be discarded directly. For a sample with a long duration, the electronic device 110 may segment it into a plurality of segments that meet the duration requirement by segmenting 703, thereby ensuring the consistency and applicability of the samples in the duration dimension. Frame rate screening 704 may eliminate video samples with low frame rates to ensure that the quality of the samples meets the basic requirements for clarity and smoothness. These operations constitute the basic layer of the quality constraint.

After the preliminary screening is completed, the electronic device 110 may perform refined filtering on the retained visual content samples. For example, an aesthetic quality score is determined for each visual content sample through aesthetic score 711. As an example, the score may measure the visual attractiveness, interestingness, artistry, color richness, etc. of the visual content sample. The electronic device 110 may use text recognition 712 to detect the text content of the visual content sample, and if inappropriate or low-quality text content is detected, it may be marked as a failed sample. Background recognition 713 may distinguish the main content of the visual content sample from the background. If the background elements are too single or uninformative, the priority of the sample will be reduced. In addition, the electronic device 110 uses content repetition recognition 714 to evaluate the dynamic richness of a sample by detecting the degree of change between video frames in the visual content sample. A sample with almost no picture change in a period of time will be marked as a low-quality sample with excessive repetition. Finally, all visual content samples with inappropriate content are eliminated through the content filtering module 715. These processes together form the core layer of the quality constraint.

For the final retained visual content samples, the electronic device 110 may label each sample with a content label 721, such as a category label of animal, person, car, etc. The motility score 722 may be used to evaluate the degree of motion change of the visual content sample over time. The degree of motion change may reflect the dynamic characteristics and provide an additional indicator for the visual content sample. On this basis, the description information 723 may refer to generating a corresponding description information sample based on the visual content sample.

The electronic device 110 may balance the number of visual content samples of different categories based on the content label to avoid too many single content categories, thereby determining the visual content samples for constructing sample pairs from the filtered visual content samples. A plurality of sample pairs is finally formed by combining the visual content samples and the generated description information samples. The above process not only ensures the quality of the sample pairs, but also improves the applicability and representativeness of the dataset by balancing the content diversity. The selected visual content samples may be used as the second visual content samples for training the decoder model 115-b. The sample pairs may be used to train the content generation model 115-a.

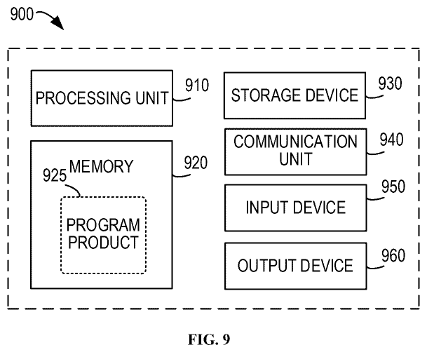

FIG. 8 shows a schematic structural block diagram of an apparatus 800 for video generation according to some embodiments of the present disclosure. The apparatus 800 may be implemented or included in the electronic device 110, for example. Each module/component in the apparatus 800 may be implemented by hardware, software, firmware, or any combination thereof.

As shown in FIG. 8, the apparatus 800 may include a position information determination module 801 configured to determine, in response to obtaining description information related to visual content generation, position information of a respective text unit in the description information based on a specified visual category, the specified visual category indicating a video category or an image category, and the position information includes at least one of spatial position information or temporal position information. A visual feature map generation module 802 is configured to generate a visual feature map matching the description information by using a trained content generation model and based on text encoding representation and the position information of the respective text unit in the description information. A visual content generation module 803 is configured to generate visual content matching the specified visual category by using a trained decoder model and based on the visual feature map, the decoder model being trained to decode an image from a visual feature map corresponding to the image and to decode a video from a visual feature map corresponding to the video.

In some embodiments of the present disclosure, the position information determination module 801 is configured to determine the spatial position information and the temporal position information of the respective text unit in response to the specified visual type indicating the video category; or determine the spatial position information of the respective text unit and set the temporal position information of the respective text unit to null values in response to the specified visual type indicating the image category.

In some embodiments of the present disclosure, the content generation model includes a diffusion model.

In some embodiments of the present disclosure, the content generation model includes a processing block based on an attention mechanism, and the visual feature map generation module 802 may be further configured to determine a query feature, a key feature and a value feature based on the description information and the position information of the respective text unit in the description information; apply normalization processing to the query feature and the key feature to obtain a normalized query feature and a normalized key feature; and provide the value feature, the normalized query feature and the normalized key feature as an input to a processing block based on cross-attention to generate the visual feature map matching the description information.

In some embodiments of the present disclosure, the apparatus 800 may further include a content generation model training module. The content generation model training module is configured to construct a plurality of first sample pairs formed by first visual content samples and first description information samples, visual categories of the first visual content samples in the plurality of first sample pairs includes a video category and an image category. For a respective first sample pair of the plurality of first sample pairs, a first visual feature map sample matching the first description information sample in the first sample pair is determined by using a content generation model to be trained. First predicted visual content matching the category of the first visual content sample is generated by using the trained decoder model and based on the first visual feature map sample. The content generation model is trained based on the difference between the first predicted visual content determined for the plurality of first sample pairs and the first visual content sample.

In some embodiments of the present disclosure, the content generation model training module may be further configured to weight the first visual content sample by using a first weight to obtain a weighted first visual content sample. Noise is weighted by using a second weight to obtain weighted noise, where the first weight and the second weight are determined based on an iteration step of iterative content generation of the content generation model. The weighted first visual content sample and the weighted noise are fused to obtain the first visual feature map sample.

In some embodiments of the present disclosure, the apparatus 800 may further include a decoder model training module. The decoder model training module is configured to process a second visual content sample by using an encoder model to obtain a second visual feature map sample of the second visual content sample. Second predicted visual content matching the second visual content sample is generated by using the decoder model to be trained and based on the second visual feature map sample. The decoder model is trained based on a difference between the second predicted visual content and the second visual content sample.

In some embodiments of the present disclosure, the encoder model includes a down-sampling layer, and the decoder model includes an up-sampling layer; the down-sampling layer is configured to down-sample, in response to the second visual content sample being a video, the second visual content sample by using a first compression stride in a spatial dimension and a second compression stride in a temporal dimension to obtain the second visual feature map sample, and down-sample, in response to the second visual content sample being an image, the second visual content sample by using the first compression stride in the spatial dimension to obtain the second visual feature map sample; and the up-sampling layer is configured to up-sample, in response to the second visual content sample being a video, the second visual feature map sample by using a first expansion stride in the spatial dimension and a second expansion stride in the temporal dimension to generate the second predicted visual content.

In some embodiments of the present disclosure, the difference between the second predicted visual content and the second visual content sample includes at least one of: a pixel distance difference between the second predicted visual content and the second visual content sample, a perceptual feature difference between the second predicted visual content and the second visual content sample, or a distribution distance difference between the second predicted visual content and the second visual content sample.

In some embodiments of the present disclosure, the apparatus 800 may further include a first sample pair construction module. The first sample pair construction module may be configured to select a plurality of visual content samples from candidate visual content samples based on a quality constraint of the visual content sample. Respective content categories corresponding to the plurality of visual content samples are determined based on semantic labels of the plurality of visual content samples. First visual content samples for constructing the plurality of first sample pairs are determined from the plurality of visual content samples based on a balance requirement for visual content samples of different content categories. Based on the first visual content samples, first description information samples related to the first visual content samples are generated to construct the first sample pair in the plurality of first sample pairs.

In some embodiments of the present disclosure, the first description information sample in the plurality of first sample pairs includes description information and a motility score for the corresponding first visual content sample, the motility score indicating a degree of motion change of the corresponding visual content sample over time.

FIG. 9 shows a block diagram of an electronic device 900 in which one or more embodiments of the present disclosure may be implemented. It should be understood that the electronic device 900 shown in FIG. 9 is only illustrative and should not constitute any limitation on the function and scope of the embodiments described herein. The electronic device 900 shown in FIG. 9 may include or be implemented as the electronic device 110 in FIG. 1 or the apparatus 800 in FIG. 8.

As shown in FIG. 9, the electronic device 900 is in the form of a general-purpose electronic device. The components of the electronic device 900 may include, but are not limited to, one or more processors or processing units 910, a memory 920, a storage device 930, one or more communication units 940, one or more input devices 950, and one or more output devices 960. The processing unit 910 may be an actual or virtual processor and may execute various processes based on the programs stored in the memory 920. In a multi-processor system, multiple processing units execute computer executable instructions in parallel to improve the parallel processing capability of the electronic device 900.

The electronic device 900 typically includes multiple computer storage medium. Such medium may be any available medium that is accessible to the electronic device 900, including, but not limited to, volatile and non-volatile medium, removable and non-removable medium. The memory 920 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 930 may be any removable or non-removable medium, and may include a machine-readable medium such as a flash drive, a disk, or any other medium, which may be used to store information and/or data and may be accessed within the electronic device 900.

The electronic device 900 may further include additional removable/non-removable, volatile/non-volatile memory medium. Although not shown in FIG. 9, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 920 may include a computer program product 925, which has one or more program modules configured to perform various methods or acts of the various embodiments of the present disclosure.

The communication unit 940 enables communication with other electronic devices through the communication medium. Additionally, the functions of the components of the electronic device 900 may be implemented by a single computing cluster or multiple computing machines, which may communicate through communication connections. Therefore, the electronic device 900 may use a logical connection with one or more other servers, a network personal computer (PC) or another network node to operate in a networked environment.

The input device 950 may be one or more input devices, such as a mouse, a keyboard, a tracking ball, etc. The output device 960 may be one or more output devices, such as a display, a speaker, a printer, etc. The electronic device 900 may also communicate with one or more external devices (not shown) as needed through the communication unit 940, the external devices such as a storage device, a display device, etc., communicate with one or more devices that enable the user to interact with the electronic device 900, or communicate with any devices (such as a network card, a modem, etc.) that enable the electronic device 900 to communicate with one or more other electronic devices. Such communication may be performed via input/output (I/O) interfaces (not shown).

According to an illustrative implementation of the present disclosure, there is provided a computer-readable storage medium having computer executable instructions stored thereon, the computer executable instructions being executed by a processor to implement the method described above. According to an illustrative implementation of the present disclosure, there is further provided a computer program product tangibly stored on a non-transitory computer-readable medium and including computer-executable instructions, the computer-executable instructions being executed by a processor to implement the method described above.

According to an illustrative implementation of the present disclosure, there is provided a computer program product or a computer program, which includes computer instructions stored in a computer-readable storage medium. The processor of the computer device reads the computer instructions from the computer-readable storage medium, and executes the computer instructions to cause the computer device to perform the method provided in various optional manners in FIG. 2, which will not be repeated herein.

Various aspects of the present disclosure are described herein with reference to flowcharts and/or block diagrams of methods, apparatuses, devices and computer program products implemented according to the present disclosure. It should be understood that each block of the flowcharts and/or block diagrams, and combinations of the blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, such that when these instructions are executed by the processing unit of the computer or other programmable data processing apparatus, an apparatus that implements the functions/actions specified in one or more blocks in the flowcharts and/or block diagrams is produced. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the functions/actions specified in one or more blocks in the flowcharts and/or block diagrams.

The computer-readable program instructions may be loaded onto a computer, other programmable data processing apparatus, or other devices, so that a series of operation steps are performed on the computer, other programmable data processing apparatus, or other devices to produce a computer-implemented process, thereby causing the instructions executed on the computer, other programmable data processing apparatus, or other devices to implement the functions/actions specified in one or more blocks in the flowcharts and/or block diagrams.

The flowcharts and block diagrams in the drawings show the possibly implemented architectures, functions and operations of the system, method and computer program product according to multiple implementations of the present disclosure. In this regard, each block in the flowchart or block diagram may represent a module, a program segment or a part of instruction, which contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combinations of the blocks in the block diagrams and/or flowcharts may be implemented by a special-purpose hardware-based system that perform the specified functions or actions, or may be implemented by a combination of special-purpose hardware and computer instructions.

The implementations of the present disclosure have been described above, and the above description is illustrative, not exhaustive, and is not limited to the disclosed implementations. Without departing from the scope of the described implementations, many modifications and changes will be apparent to those of ordinary skill in the art. The terms used herein are chosen to best explain the principles of the implementations, the practical applications, or improvements to the technologies in the market, or to enable other ordinary skilled artisans in the art to understand the implementations disclosed herein.

1. A method of visual content generation, comprising:
determining, in response to obtaining description information related to visual content generation, position information of a respective text unit in the description information based on a specified visual category, the specified visual category indicating a video category or an image category, the position information comprising at least one of spatial position information or temporal position information;
generating a visual feature map matching the description information by using a trained content generation model and based on text encoding representation and the position information of the respective text unit in the description information; and
generating visual content matching the specified visual category by using a trained decoder model and based on the visual feature map, the decoder model being trained to decode an image from a visual feature map corresponding to the image and to decode a video from a visual feature map corresponding to the video.

2. The method of claim 1, wherein determining the position information comprises:
determining, in response to the specified visual type indicating the video category, the spatial position information and the temporal position information of the respective text unit; and
determining the spatial position information of the respective text unit and setting the temporal position information of the respective text unit to a null value in response to the specified visual type indicating the image category.

3. The method of claim 1, wherein the content generation model comprises a diffusion model.

4. The method of claim 1, wherein the content generation model comprises a processing block based on an attention mechanism, and wherein generating the visual feature map matching the description information comprises:
determining a query feature, a key feature and a value feature based on the description information and the position information of the respective text unit in the description information;
applying normalization processing to the query feature and the key feature to obtain a normalized query feature and a normalized key feature; and
providing the value feature, the normalized query feature and the normalized key feature as an input to a processing block based on cross-attention to generate the visual feature map matching the description information.

5. The method of claim 1, wherein the content generation model is trained by:
constructing a plurality of first sample pairs formed by first visual content samples and first description information samples, visual categories of the first visual content samples in the plurality of first sample pairs comprising a video category and an image category;
for a respective first sample pair of the plurality of first sample pairs:
determining, by using a content generation model to be trained, a first visual feature map sample matching the first description information sample in the first sample pair;
generating, by using the trained decoder model and based on the first visual feature map sample, first predicted visual content matching a category of the first visual content sample; and
training the content generation model based on differences between the determined first predicted visual content and the first visual content samples for the plurality of first sample pairs.

6. The method of claim 5, wherein determining the first visual feature map sample matching the first description information sample in the sample pair comprises:
weighting the first visual content sample by using a first weight to obtain a weighted first visual content sample;
weighting noise by using a second weight to obtain weighted noise, wherein the first weight and the second weight are determined based on an iteration step of iterative content generation of the content generation model; and
fusing the weighted first visual content sample and the weighted noise to obtain the first visual feature map sample.

7. The method of claim 1, wherein the decoder model is trained by:
processing a second visual content sample by using an encoder model to obtain a second visual feature map sample of the second visual content sample;
generating, by using the decoder model to be trained and based on the second visual feature map sample, second predicted visual content matching the second visual content sample; and
training the decoder model based on a difference between the second predicted visual content and the second visual content sample.

8. The method of claim 7, wherein the encoder model comprises a down-sampling layer, and the decoder model comprises an up-sampling layer;
wherein the down-sampling layer is configured to:
down-sample, in response to the second visual content sample being a video, the second visual content sample by using a first compression stride in a spatial dimension and a second compression stride in a temporal dimension to obtain the second visual feature map sample, and
down-sample, in response to the second visual content sample being an image, the second visual content sample by using the first compression stride in the spatial dimension to obtain the second visual feature map sample; and
wherein the up-sampling layer is configured to:
up-sample, in response to the second visual content sample being a video, the second visual feature map sample by using a first expansion stride in the spatial dimension and a second expansion stride in the temporal dimension to generate the second predicted visual content.

9. The method of claim 7, wherein the difference between the second predicted visual content and the second visual content sample comprises at least one of:
a pixel distance difference between the second predicted visual content and the second visual content sample,
a perceptual feature difference between the second predicted visual content and the second visual content sample, or
a distribution distance difference between the second predicted visual content and the second visual content sample.

10. The method of claim 5, wherein constructing the plurality of first sample pairs formed by the first visual content samples and the first description information samples comprises:
selecting a plurality of visual content samples from candidate visual content samples based on a quality constraint of the visual content sample;
determining respective content categories corresponding to the plurality of visual content samples based on semantic labels of the plurality of visual content samples;
determining, based on a balance requirement for visual content samples of different content categories, first visual content samples for constructing the plurality of first sample pairs from the plurality of visual content samples; and
generating, based on the first visual content samples, first description information samples related to the first visual content samples to construct the first sample pair in the plurality of first sample pairs.

11. The method of claim 5, wherein the first description information sample in the plurality of first sample pairs comprises description information and a motility score for the corresponding first visual content sample, the motility score indicating a degree of motion change of the corresponding visual content sample over time.

12. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
determining, in response to obtaining description information related to visual content generation, position information of a respective text unit in the description information based on a specified visual category, the specified visual category indicating a video category or an image category, the position information comprising at least one of spatial position information or temporal position information;
generating a visual feature map matching the description information by using a trained content generation model and based on text encoding representation and the position information of the respective text unit in the description information; and
generating visual content matching the specified visual category by using a trained decoder model and based on the visual feature map, the decoder model being trained to decode an image from a visual feature map corresponding to the image and to decode a video from a visual feature map corresponding to the video.

13. The electronic device of claim 12, wherein determining the position information comprises:
determining, in response to the specified visual type indicating the video category, the spatial position information and the temporal position information of the respective text unit; and
determining the spatial position information of the respective text unit and setting the temporal position information of the respective text unit to a null value in response to the specified visual type indicating the image category.

14. The electronic device of claim 12, wherein the content generation model comprises a diffusion model.

15. The electronic device of claim 12, wherein the content generation model comprises a processing block based on an attention mechanism, and wherein generating the visual feature map matching the description information comprises:
determining a query feature, a key feature and a value feature based on the description information and the position information of the respective text unit in the description information;
applying normalization processing to the query feature and the key feature to obtain a normalized query feature and a normalized key feature; and
providing the value feature, the normalized query feature and the normalized key feature as an input to a processing block based on cross-attention to generate the visual feature map matching the description information.

16. The electronic device of claim 12, wherein the content generation model is trained by:
constructing a plurality of first sample pairs formed by first visual content samples and first description information samples, visual categories of the first visual content samples in the plurality of first sample pairs comprising a video category and an image category;
for a respective first sample pair of the plurality of first sample pairs:
determining, by using a content generation model to be trained, a first visual feature map sample matching the first description information sample in the first sample pair;
generating, by using the trained decoder model and based on the first visual feature map sample, first predicted visual content matching a category of the first visual content sample; and
training the content generation model based on differences between the determined first predicted visual content and the first visual content samples for the plurality of first sample pairs.

17. The electronic device of claim 16, wherein determining the first visual feature map sample matching the first description information sample in the sample pair comprises:
weighting the first visual content sample by using a first weight to obtain a weighted first visual content sample;
weighting noise by using a second weight to obtain weighted noise, wherein the first weight and the second weight are determined based on an iteration step of iterative content generation of the content generation model; and
fusing the weighted first visual content sample and the weighted noise to obtain the first visual feature map sample.

18. The electronic device of claim 12, wherein the decoder model is trained by:
processing a second visual content sample by using an encoder model to obtain a second visual feature map sample of the second visual content sample;
generating, by using the decoder model to be trained and based on the second visual feature map sample, second predicted visual content matching the second visual content sample; and
training the decoder model based on a difference between the second predicted visual content and the second visual content sample.

19. The electronic device of claim 18, wherein the encoder model comprises a down-sampling layer, and the decoder model comprises an up-sampling layer;
wherein the down-sampling layer is configured to:
down-sample, in response to the second visual content sample being a video, the second visual content sample by using a first compression stride in a spatial dimension and a second compression stride in a temporal dimension to obtain the second visual feature map sample, and
down-sample, in response to the second visual content sample being an image, the second visual content sample by using the first compression stride in the spatial dimension to obtain the second visual feature map sample; and
wherein the up-sampling layer is configured to:
up-sample, in response to the second visual content sample being a video, the second visual feature map sample by using a first expansion stride in the spatial dimension and a second expansion stride in the temporal dimension to generate the second predicted visual content.

20. A non-transitory computer-readable storage medium having a computer program stored thereon, the computer program being executable by a processor to implement acts comprising:
determining, in response to obtaining description information related to visual content generation, position information of a respective text unit in the description information based on a specified visual category, the specified visual category indicating a video category or an image category, the position information comprising at least one of spatial position information or temporal position information;
generating a visual feature map matching the description information by using a trained content generation model and based on text encoding representation and the position information of the respective text unit in the description information; and
generating visual content matching the specified visual category by using a trained decoder model and based on the visual feature map, the decoder model being trained to decode an image from a visual feature map corresponding to the image and to decode a video from a visual feature map corresponding to the video.
